(19) United States
(12) Patent Application Publication
(10) Pub. No.: US 2015/0113144 A1
(43) Pub. Date: Apr. 23, 2015

(54) VIRTUAL RESOURCE PLACEMENT FOR CLOUD-BASED APPLICATIONS AND SOLUTIONS

(71) Applicant: Alcatel-Lucent USA Inc., Murray Hill, NJ (US)

(72) Inventors: Eric J. Bauer, Freehold, NJ (US); Randee Susan Adams, Naperville, IL (US); Mark M. Clougherty, Chatham, NJ (US)

(73) Assignee: Alcatel-Lucent USA Inc., Murry Hill, NJ (US)

(21) Appl. No.: 14/058,413

(22) Filed: Oct. 21, 2013

(51) Int. Cl. H04L 12/911

(52) U.S. Cl. CPC H04L 47/70
USPC 709/226

(57) ABSTRACT

A virtual resource placement management capability is presented herein. The virtual resource placement management capability enables a cloud consumer to manage placement of virtual resources of the cloud consumer by a cloud service provider within a cloud environment of the cloud service provider. The virtual resource placement management capability may support management of placement of virtual resources of a cloud consumer onto physical resources of a cloud service provider (e.g., physical resources used by the cloud service provider to provide a cloud environment), which also may be referred to herein as mapping of virtual resources of a cloud consumer onto physical resources of a cloud service provider. The virtual resource placement management capability may support management of placement of virtual resources of a cloud-based application or a cloud-based solution of a cloud consumer onto physical resources of a cloud service provider.

### TECHNICAL FIELD

The disclosure relates generally to cloud-based services and, more specifically but not exclusively, to managing placement of virtual resources using cloud-based services.

### BACKGROUND

The use of cloud-based services of cloud service providers to host applications and solutions continues to gain popularity with cloud consumers. The cloud consumers request virtual resources from the cloud service providers, and the cloud service providers allocate the virtual resources requested by the cloud consumers. The cloud consumers often desire use of sophisticated rules by cloud service providers to support the cloud-based applications or solutions of the cloud consumers. In many cases, however, the cloud service providers are unable or unwilling to use the sophisticated rules desired by the cloud consumers.

### SUMMARY OF EMBODIMENTS

Various deficiencies in the prior art are addressed by embodiments for managing placement of virtual resources of a cloud consumer within a cloud environment of a cloud service provider.

In at least some embodiments, an apparatus includes a processor and a memory communicatively connected to the processor, where the processor is configured to receive configuration information indicative of placement of virtual resources of a cloud consumer on physical resources of a cloud environment of a cloud service provider, receive a virtual resource placement policy of the cloud consumer, and determine, based on the configuration information and the virtual resource placement policy of the cloud consumer, whether the placement of the virtual resources of the cloud consumer on the physical resources of the cloud service provider satisfies or violates the virtual resource placement policy of the cloud consumer.

In at least some embodiments, a method includes using a processor and a memory for receiving configuration information indicative of placement of virtual resources of a cloud consumer on physical resources of a cloud environment of a cloud service provider, receiving a virtual resource placement policy of the cloud consumer, and determining, based on the configuration information and the virtual resource placement policy of the cloud consumer, whether the placement of the virtual resources of the cloud consumer on the physical resources of the cloud service provider satisfies or violates the virtual resource placement policy of the cloud consumer.

In at least some embodiments, a computer-readable storage medium stores instructions which, when executed by a computer, cause the computer to perform a method including receiving configuration information indicative of placement of virtual resources of a cloud consumer on physical resources of a cloud environment of a cloud service provider, receiving a virtual resource placement policy of the cloud consumer, and determining, based on the configuration information and the virtual resource placement policy of the cloud consumer, whether the placement of the virtual resources of the cloud consumer on the physical resources of the cloud service provider satisfies or violates the virtual resource placement policy of the cloud consumer.

### BRIEF DESCRIPTION OF THE DRAWINGS

The teachings herein can be readily understood by considering the detailed description in conjunction with the accompanying drawings, in which:

FIG. 1 depicts an exemplary communication system including a cloud environment of a cloud service provider and a virtual resource placement management system of a cloud consumer that is configured to manage placement of virtual resources of the cloud consumer within the cloud environment of the cloud service provider;

FIG. 2 depicts an exemplary datacenter of the cloud environment of FIG. 1;

FIG. 3 depicts an exemplary embodiment of a method for use by a cloud consumer in managing placement of virtual resources of the cloud consumer in a cloud environment of a cloud service provider;

FIG. 4 depicts an exemplary embodiment of a method for managing placement of virtual resources of a cloud consumer in a cloud environment of a cloud service provider; and

FIG. 5 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

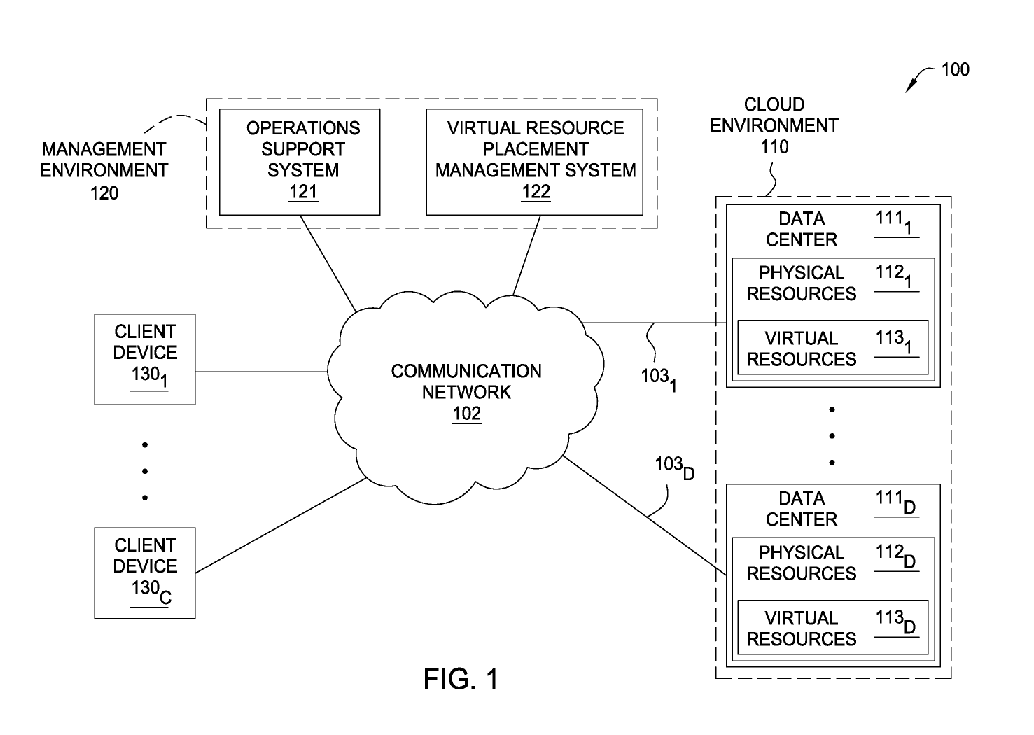

A virtual resource placement management capability is presented herein. The virtual resource placement management capability enables a cloud consumer to manage placement of virtual resources of the cloud consumer by a cloud service provider within a cloud environment of the cloud service provider. The virtual resource placement management capability enables a cloud consumer to manage placement of virtual resources by a cloud service provider on behalf of the cloud consumer, as the cloud consumer is not expected to have control over placement of virtual resources within the cloud environment of the cloud service provider. The virtual resource placement management capability may support management of placement of virtual resources of a cloud consumer onto physical resources of a cloud service provider (e.g., physical resources used by the cloud service provider to provide a cloud environment), which also may be referred to herein as mapping of virtual resources of a cloud consumer onto physical resources of a cloud service provider. The placement or mapping of virtual resources of a cloud consumer onto physical resources of cloud environment of a cloud service provider may include allocation of the virtual resources at specific locations within cloud environment (e.g., onto specific physical resources of the cloud environment of the cloud service provider). The virtual resource placement management capability may support management of placement of virtual resources of a cloud-based application or a cloud-based solution of a cloud consumer onto physical resources of a cloud service provider. In at least some embodiments, management of placement of virtual resources of a cloud consumer onto physical resources of a cloud service provider may include receiving configuration information indicative of placement of virtual resources of the cloud consumer onto physical resources of the cloud service provider and auditing the placement of the virtual resources of the cloud consumer onto the physical resources of the cloud service provider based on the configuration information and a resource placement policy of the cloud consumer to determine whether the placement of the virtual resources of the cloud consumer onto the physical resources of the cloud service provider complies with or violates the virtual resource placement policy of the cloud consumer. In at least some embodiments, management of placement of virtual resources of the cloud consumer onto physical resources of a cloud service provider may further include determining, based on a determination that the placement of the virtual resources of the cloud consumer onto the physical resources of the cloud service provider violates the virtual resource placement policy of the cloud consumer, a set of corrective actions configured to (or at least tending or expected to) modify the placement of the virtual resources of the cloud consumer onto the physical resources of the cloud service provider such that the placement of the virtual resources of the cloud consumer onto the physical resources of the cloud service provider satisfies the virtual resource placement policy of the cloud consumer. It will be appreciated that, although primarily depicted and described herein, for purposes of clarity, within the context of managing placement of specific types of virtual resources within a specific type of environment (namely, placement of virtual machines within datacenters of a cloud service provider), various embodiments of the virtual resource placement management capability may be configured to manage placement of various other types of virtual resources or within various other types of environments. These and various other embodiments of the virtual resource placement management capability may be better understood by way of reference to an exemplary communication system configured to support hosting and use of one or more cloud-based applications or one or more cloud-based solutions, as depicted and described with respect to FIG. 1.

FIG. 1 depicts an exemplary communication system including a cloud environment of a cloud service provider and a virtual resource placement management system of a cloud consumer that is configured to manage placement of virtual resources of the cloud consumer within the cloud environment of the cloud service provider.

The exemplary communication system 100 includes a communication network 102, a cloud environment (CE) 110 of a cloud service provider that includes a plurality of datacenters (DCs) 111₁-111_{D} (collectively, DCs 111), and a management environment (ME) 120 of a cloud consumer that includes an operations support system (OSS) 121 and a virtual resource placement management system (VRPMS) 122, and a plurality of client devices (CDs) 130₁-130c (collectively, CDs 130).

The communication network 102 may include any communication network(s) suitable for facilitating communications within communication system 100 (e.g., between DCs 111, between elements of ME 120 and DCs 111, between CDs 130 and DCs 111, or the like). The communication network 102 may include various numbers and configurations of devices (e.g., access devices, network devices, or the like), communication links (e.g., access links, backhaul links, or the like), or the like, as well as various combinations thereof. For example, communication network 102 may include one or more wireline networks or one or more wireless networks, which may include one or more of a Global System for Mobile (GSM) based network, a Code Divisional Multiple Access (CDMA) based network, a Long Term Evolution (LTE) based network, a Local Area Network (LAN), a Wireless Local Area Network(s) (WLAN), a Metropolitan Area Network (MAN), a Wide Area Network (WAN), or the like.

In FIG. 1, the cloud service provider of CE 110 offers various cloud services, including hosting of virtual resources for cloud consumers (e.g., the cloud consumer associated with ME 120) within the CE 110 of the cloud service provider. The cloud service provider of CE 110 may support one or more of a cloud-based application, a set of cloud-based applications, a cloud-based solution, or the like, as well as various combinations thereof. The cloud service provider of CE 110 may support hosting of application instances or solution instances which may be configured to service requests from CDs 130.

The DCs 111 of CE 110 may be configured to support cloud services for cloud consumers. The DCs 111 of CE 110 may include various types and configurations of resources which may be used to support cloud services for cloud consumers. The resources may include various types and configurations of physical resources which may be used to support various types and configurations of virtual resources. The DCs 111 may be geographically distributed. The DCs 111₁-111_{D} may communicate with communication network 102 via respective communication paths 103₁-103_{D} (collectively, communication paths 103).

The DCs 111 of CE 110 include respective sets of physical resources (PRs) 112₁-112_{D} (collectively, PRs 112) which may be used to provide cloud services for cloud consumers. For example, PRs 112 of a DC 111 may include computing resources, memory resources, storage resources, networking resources, or the like. For example, PRs 112 of a DC 111 may include servers, processor cores, memory devices, storage devices, networking devices (e.g., switches, routers, or the like), communication links, or the like. More specifically, for example, PRs 112 of a DC 111 may include host servers configured to host virtual resources within the DC 111 (e.g., including server blades organized in racks and connected via respective top-of-rack (TOR) switches, hypervisors, or the like), aggregating switches and routers configured to support communications of host servers within the DC 111 (e.g., between host servers within the DC 111, between host servers of DC 111 and devices located outside of the DC 111, or the like), or the like, as well as various combinations thereof. The typical configuration and operation of PRs of a datacenter (e.g., such as PRs 112 of one or more of the DCs 111) will be understood by one skilled in the art.

The PRs 112 of the DCs 111 of CE 110 are configured to support respective sets of virtual resources (VRs) 113₁-113_{D} (collectively, VRs 113) for cloud consumers. For example, VRs 113 supported using PRs 112 of a DC 111 may include virtual computing resources, virtual memory resources, virtual storage resources, virtual networking resources, or the like, as well as various combinations thereof (e.g., virtual machines (VMs), virtual file systems (VFSs), or the like). The typical configuration and operation of VRs using PRs of a datacenter (e.g., such as VRs 113 using PRs 112 of one or more of the DCs 111) will be understood by one skilled in the art.

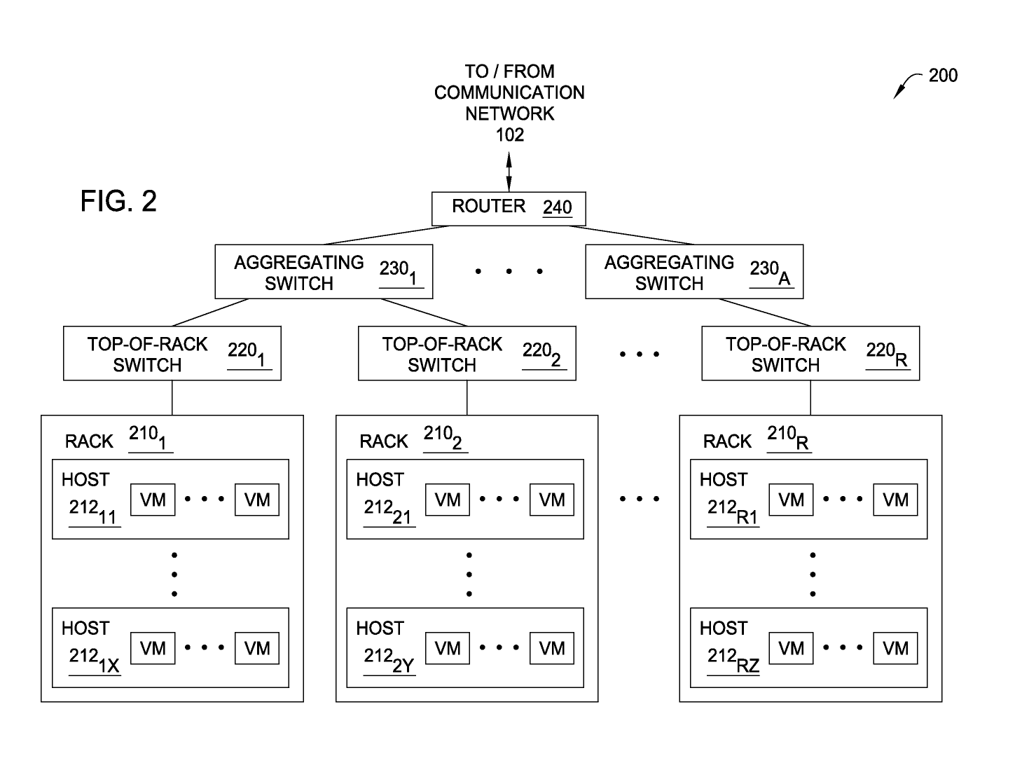

FIG. 2 depicts an exemplary datacenter of the cloud environment of FIG. 1. The DC 200 includes a plurality of racks 210₁-210_{R} (collectively, racks 210). The racks 210₁-201_{R} house respective sets of hosts 212₁₁-212_{1X} (collectively, hosts 212₁ which are, illustratively, housed within rack 210₁), hosts 212₂₁-212_{2Y} (collectively, hosts 212₂ which are, illustratively, housed within rack 210₂), and hosts 212_{R1}-212R_{RZ} (collectively, hosts 212_{R} which are, illustratively, housed within rack 210_{R}). The hosts 212₁-212_{R} may be referred to collectively as hosts 212. The hosts 212 may be any devices suitable for hosting virtual resources within DC 200, such as host servers, blade servers, processors, processor cores, or the like, as well as various combinations thereof. The hosts 212 each may include various physical resources configured to support virtual resources, such as computing resources, memory devices, storage devices, input-output resources, or the like. The hosts 212 each may support various types of virtual resources. As depicted in FIG. 2, each of the hosts 212 hosts one or more VMs configured to support application instances, solution instances, or the like. The DC 200 also includes a plurality of top-of-rack (ToR) switches 220₁-220_{R} (collectively, ToR switches 220) associated with respective racks 210₁-210_{R}, where a ToR switch 220 associated with a rack 210 is configured to support communications for that rack 210 (e.g., between VMs of hosts 212 within that rack 210, between VMs of hosts 212 within that rack 210 and any other devices located outside of that rack 210, or the like). The DC 200 also includes a plurality of aggregating switches 230₁-230_{A} (collectively, aggregating switches 230), where an aggregating switch 230 is configured to support communications for two or more of the ToR switches 220. For example, aggregating switch 230₁ is depicted as supporting communications of VMs of hosts 212 of racks 210₁ and 210₂. The DC 200 also includes a router 240, which is configured to support communications for the aggregating switches 230, thereby facilitating communications by any elements of DC 200 (e.g., between VMs of hosts 212 within DC 200, between VMs of hosts 212 within DC 200 and any other devices located outside of DC 200, or the like). The DC 200 is suitable for use as any of the DCs 111 of FIG. 1. It will be appreciated that the configuration of DC 200 is merely exemplary and, thus, that any of the DCs 111 of FIG. 1 may have any other suitable configuration. The use of a DC of a cloud service provider (such as exemplary DC 200 of FIG. 2) to provide cloud services may be better understood by way of reference back to FIG. 1.

In FIG. 1, the cloud consumer of ME 120 is a customer of the cloud service provider of CE 110. The cloud consumer intends to use cloud-based resources of the cloud service provider, rather than dedicated hardware, to provide one or more cloud services. The cloud consumer and cloud service provider enter into an agreement to have the cloud service provider provide virtual resources supporting the one or more services to be provided by the cloud consumer. For example, the cloud consumer may request virtual resources from the cloud service provider, where the virtual resources may be used to provide a cloud-based application, a set of cloud-based applications, a cloud-based solution, or the like, as well as various combinations thereof.

For example, the cloud consumer may be a company offering an application for use by end users (e.g., requesting a total of 20 VMs to be hosted in DCs 111 geographically distributed across a geographic area in which the application is to be offered). For example, users of CDs 130 may use the application offered by the cloud consumer.

For example, the cloud consumer may be a wireless service provider offering a wireless communication solution for end users. For example, the cloud consumer may be a wireless service provider offering a voice-over-LTE service for end users (e.g., requesting a total of 1000 VMs hosted in DCs 111 geographically distributed across a geographic area in which the voice-over-LTE service is to be offered, where various subsets of the VMs may be used to support functions such as Serving Gateway (SGW) functions, Packet Data Network (PDN) Gateway (PGW) functions, Mobility Management Entity (MME) functions, and the like). For example, users of CDs 130 may subscribe to wireless services from the cloud consumer.

The cloud consumer uses ME 120 to manage virtual resources hosted for the cloud consumer within CE 110 of the cloud service provider.

The OSS 121 is configured to manage the elements or functions used to provide the application or solution of the cloud consumer. For example, where the cloud consumer uses VRs 113 of CE 110 to host an application, the OSS 121 may be configured to manage functions provided by the application. For example, where the cloud consumer uses VRs 113 of CE 110 to host a voice-over-LTE service, the OSS 121 may be configured to manage elements such as SGWs, PGWs, MMEs, or the like. For example, the OSS 121 may include or represent one or more of an element management system (EMS), a network management system (NMS), a provisioning system, a fault detection system, a fault management system, or the like, as well as various combinations thereof.

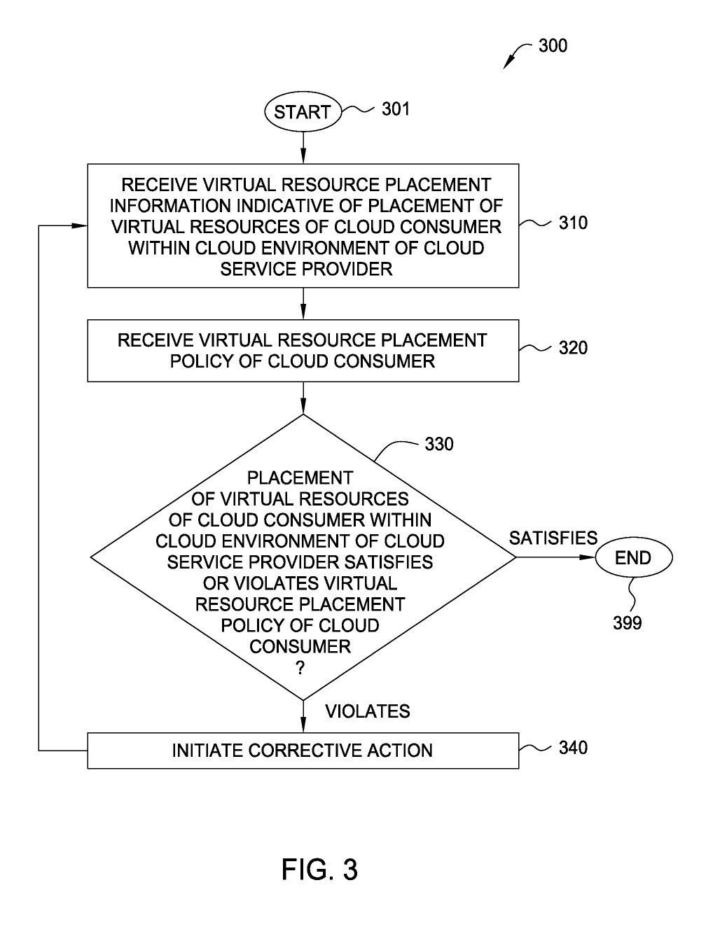

The VRPMS 122 is configured to audit the placement of VRs 113 of the cloud consumer within CE 110 of the cloud service provider. The VRPMS 122 is configured to audit the placement of VRs 113 of the cloud consumer within CE 110 of the cloud service provider in order determine whether the placement of VRs 113 of the cloud consumer within CE 110 of the cloud service provider satisfies or violates a virtual resource placement policy of the cloud consumer. The VRPMS 122 may be configured to audit the placement of VRs 113 of the cloud consumer periodically (e.g., once each hour, once per day, or the like), in response to a trigger condition (e.g., detection of a fault or error, initiation of a request for additional virtual resources, or the like), or the like, as well as various combinations thereof. An exemplary embodiment of a method for auditing the placement of the virtual resources of the cloud consumer within CE 110 of the cloud service provider is depicted and described with respect to FIG. 3. It will be appreciated that, although primarily depicted and described as separate elements, in at least some embodiments the OSS 121 and VRPMS 122 may be combined within a common element or system. It will be appreciated that the management environment of a cloud consumer may include various other types and arrangements of systems.

The CDs 130 include devices configured for use in accessing and using cloud-based services from CE 110 via communication network 102. For example, the CDs 130 may include devices operated by users of the cloud consumer. For example, a CD 130 may be a thin client, a smartphone, a tablet computer, a laptop computer, a desktop computer, a television set-top-box, a media player, a gateway, a server, a network device, or the like.

It will be appreciated that, although primarily depicted and described with respect to an exemplary communication system including specific types, numbers, and arrangements of elements and resources, the communication system within which embodiments of the virtual resource placement management capability may be provided may include any other suitable types, numbers, or arrangements of elements and resources.

FIG. 3 depicts an exemplary embodiment of a method for use by a cloud consumer in managing placement of virtual resources of the cloud consumer in a cloud environment of a cloud service provider. It will be appreciated that method 300 of FIG. 3 may be performed at any suitable granularity (e.g., for a cloud-based application of the cloud consumer, for a set of cloud-based applications of the cloud consumer, for a cloud-based solution of the cloud consumer, or the like, as well as various combinations thereof). It will be appreciated that, while primarily depicted and described herein as being performed serially, at least a portion of the steps of method 300 of FIG. 3 may be performed contemporaneously or in a different order than presented in FIG. 3.

At step 301, method 300 begins.

At step 310, virtual resource placement information is received. The virtual resource placement information is indicative of the placement of the virtual resources of the cloud consumer within the cloud environment of the cloud service provider. The virtual resource placement information is indicative of the placement of the virtual resources of the cloud consumer onto the physical resources of the cloud service provider which, as noted above, also may be referred to as the mapping of the virtual resources of the cloud consumer onto the physical resources of the cloud service provider. The placement or mapping of virtual resources of a cloud consumer onto physical resources of cloud environment of a cloud service provider may include allocation of the virtual resources at specific locations within cloud environment (e.g., onto specific physical resources of the cloud environment of the cloud service provider).

The virtual resource placement information may include any information describing placement of virtual resources of the cloud consumer within the cloud environment of the cloud service provider. The virtual resource placement information may include mappings of virtual resources of the cloud consumer to physical resources of datacenters of the cloud service provider. For example, the virtual resource placement information may identify, for each VM of the cloud consumer, the physical server on which the VM is hosted. For example, the virtual resource placement information may identify, for each VM of the cloud consumer, the CPU on which the VM is hosted. The virtual resource placement information may include any other suitable information indicative of placement of virtual resources of the cloud consumer within the cloud environment of the cloud service provider.

The virtual resource placement information may be determined from any suitable source(s) of such information. For example, at least a portion of the virtual resource placement information may be obtained from one or more systems of the cloud consumer (e.g., one or more OSSs) where such virtual resource placement information is provided to the cloud consumer by the cloud service provider or collected from the cloud service provider by the cloud consumer. For example, at least a portion of the virtual resource placement information may be obtained from the cloud service provider (e.g., via one or more requests to one or more systems or other elements of the cloud service provider). For example, at least a portion of the virtual resource placement information may be obtained by determining or inferring such information based on one or more of analysis of communications with the cloud environment of the cloud service provider (e.g., communications between client devices of the cloud consumer and VMs of the cloud service provider), analysis of use of virtual resources by the cloud consumer. In other words, it will be appreciated that various portions of the virtual resource placement information may be received from various sources of such information, where portions of such information may be collected over time and accessed when needed or desired or collected on-the-fly in real time or near-real-time when needed or desired.

At step 320, a virtual resource placement policy of the cloud consumer is received. The virtual resource placement policy of the cloud consumer may include one or more virtual resource placement rules according to which the cloud consumer requires or desires virtual resources that are allocated to the cloud consumer by the cloud service provider to conform.

For example, the virtual resource placement rules may include one or more anti-affinity rules (e.g., a server-based anti-affinity rule, a rack-based anti-affinity rule, a datacenter-based anti-affinity rule, or the like), one or more single-point-of-failure (SPOF) rules (e.g., a processor-based SPOF prevention rule, a server-based SPOF prevention rule, a rack-based SPOF prevention rule, a datacenter-based SPOF prevention rule, or the like), one or more ‘anywhere-but-here’ rules (e.g., a processor-based ‘anywhere-but-here’ rule, a server-based ‘anywhere-but-here’ rule, a rack-based ‘anywhere-but-here’ rule, a datacenter-based ‘anywhere-but-here’ rule, or the like), or the like, as well as various combinations thereof.

For example, the virtual resource placement rules may include an application-specific virtual resource placement rule that is based on one or more characteristics of an cloud-based application for which the virtual resources are used by the cloud consumer, an application-specific virtual resource placement rule that is based on one or more characteristics of an cloud-based application which forms part of a cloud-based solution for which the virtual resources are used by the cloud consumer, a solution-specific virtual resource placement rule that is based on one or more characteristics of a cloud-based solution for which the virtual resources are used by the cloud consumer, or the like. For example, application-specific or solution-specific virtual resource placement rules may include a rule specifying that no more than X users are to be served from a single physical server, no more than Y users are to be served from a single physical rack, no more than Z users are to be served from a single datacenter, or the like).

For example, the virtual resource placement rules may include an intra-function virtual resource placement rule adapted to take into account one or more characteristics of a function of a cloud-based application or solution for which the virtual resources are used by the cloud consumer, an inter-function virtual resource placement rule adapted to take into account characteristics of a set of two or more functions of a cloud-based application or solution for which the virtual resources are used by the cloud consumer, or the like.

The virtual resource placement rules may include various other types of rules according to which the cloud consumer expects or desires its virtual resources to be placed within the cloud environment of the cloud service provider.

At step 330, a determination is made as to whether the placement of the virtual resources of the cloud consumer within the cloud environment of the cloud service provider satisfies or violates the virtual resource placement policy. The determination as to whether the placement of the virtual resources of the cloud consumer within the cloud environment of the cloud service provider satisfies or violates the virtual resource placement policy may be a determination as to whether the placement of the virtual resources of the cloud consumer onto physical resources of the cloud service provider satisfies or violates the virtual resource placement policy. The determination as to whether the placement of the virtual resources of the cloud consumer within the cloud environment of the cloud service provider satisfies or violates the virtual resource placement policy is made by auditing the placement of the virtual resources of the cloud consumer within the cloud environment of the cloud service provider based on the virtual resource placement information and the virtual resource placement policy. The determination as to whether the placement of the virtual resources of the cloud consumer within the cloud environment of the cloud service provider satisfies or violates the virtual resource placement policy may be a determination as to whether the placement of the virtual resources of the cloud consumer within the cloud environment of the cloud service provider satisfies or violates a threshold number of virtual resource placement rules of the virtual resource placement policy (e.g., violation of one or more virtual resource placement rules may be deemed to be a violation of the virtual resource placement policy, violation of 10% or more of the virtual resource placement rules may be deemed to be a violation of the virtual resource placement policy, or the like). If a determination is made that the placement of the virtual resources of the cloud consumer within the cloud environment of the cloud service provider satisfies the virtual resource placement policy, method 300 proceeds to step 399 where method 300 ends. If a determination is made that the placement of the virtual resources of the cloud consumer within the cloud environment of the cloud service provider violates the virtual resource placement policy, method 300 proceeds to step 340.

At step 340, corrective action is initiated based on the determination that the placement of the virtual resources of the cloud consumer within the cloud environment of the cloud service provider violates the virtual resource placement policy.

The corrective action may include determining one or more virtual resource configuration actions configured for modifying the placement of the virtual resources of the cloud consumer within the cloud environment of the cloud service provider, and communicating the one or more virtual resource configuration actions to the cloud service provider for causing modification of the placement of the virtual resources of the cloud consumer within the cloud environment of the cloud service provider. It is noted that, since the cloud service provider may be unable or unwilling to handle relatively complex virtual resource configuration actions which may be required in order to ensure that the placement of the virtual resources of the cloud consumer within the cloud environment of the cloud service provider satisfies the virtual resource placement policy of the cloud consumer (e.g., detailed specification by the cloud consumer of physical servers on which VMs can or cannot be allocated, detailed specification by the cloud consumer of racks in which VMs can or cannot be allocated), the cloud consumer may be limited to use of relatively simple virtual resource configuration actions which the cloud consumer expects or hopes will modify the placement of the virtual resources of the cloud consumer within the cloud environment of the cloud service provider such that the modified placement of the virtual resources of the cloud consumer within the cloud environment of the cloud service provider satisfies the virtual resource placement policy of the cloud consumer (e.g., requesting allocation of a new VM that the cloud consumer hopes will not be placed on a particular physical server that will result in violation of the virtual resource placement policy of the cloud consumer, requesting allocation of a new VM that the cloud consumer hopes will not be placed on a particular rack that will result in violation of the virtual resource placement policy of the cloud consumer, or the like). As a result, the cloud consumer may not know whether or not the one or more virtual resource configuration actions being provided to the cloud service provider will result in a modified placement of the virtual resources of the cloud consumer within the cloud environment of the cloud service provider that satisfies the virtual resource placement policy of the cloud service provider. Accordingly, after the cloud service provider has executed the one or more virtual resource configuration actions specified by the cloud consumer to produce the modified placement of the virtual resources of the cloud consumer within the cloud environment of the cloud service provider, the cloud consumer may then audit the modified placement of the virtual resources of the cloud consumer within the cloud environment of the cloud service provider to determine whether the modified placement of the virtual resources of the cloud consumer within the cloud environment of the cloud service provider satisfies virtual resource placement policy of the cloud consumer. This is depicted as feedback from step 340 to step 310, at which point the cloud consumer receives virtual resource placement information for the modified placement of the virtual resources of the cloud consumer within the cloud environment of the cloud service provider. Therefore, the cloud consumer may perform any number of iterations of auditing and modifying the placement of the virtual resources of the cloud consumer within the cloud environment of the cloud service provider that may be necessary until the placement of the virtual resources of the cloud consumer within the cloud environment of the cloud service provider satisfies the virtual resource placement policy of the cloud consumer. It is noted that, in subsequent loops through method 300 of FIG. 3, it may or may not be required for the virtual resource placement policy of the cloud consumer to be received or obtained again (e.g., it may be necessary where the virtual resource placement policy is known or expected to have changed since the previous audit, or it may not be necessary where the virtual resource placement policy is known not to have changed since the previous audit).

For example, where auditing of the placement of the virtual resources of the cloud consumer on the physical resources of the cloud service provider results in a determination by the cloud consumer that two VMs providing a given function have been allocated by the cloud service provider on the same physical server in violation of the virtual resource placement policy of the cloud consumer which requires that no VMs providing the same function be allocated on the same physical server, the cloud consumer may wish to have one of the two VMs providing the function moved to a different physical server. However, the cloud service provider may be unable or unwilling to handle such a complex request. Accordingly, the cloud consumer may request allocation of a new VM configured to provide the function, with an expectation or hope that the new VM configured to provide the function will be allocated by the cloud service provider on a physical server other than the physical server on which the two VMs providing the function are already allocated. The allocation of the new VM by the cloud service provider results in a modified placement of the virtual resources of the cloud consumer on the physical resources of the cloud service provider. The cloud service provider may then obtain new virtual resource placement information and determine whether the modified placement of the virtual resources of the cloud consumer within the cloud environment of the cloud service provider satisfies or violates the virtual resource placement policy. The cloud consumer, based on a determination that the placement of the new VM by the cloud service provider satisfies the virtual resource placement policy, may then migrate users or connections off of one of the two VMs that violated the virtual resource placement policy onto the new VM and then request deallocation of the one of the two VMs that violated the virtual resource placement policy from which the users or connections were migrated.

For example, where auditing of the placement of the virtual resources of the cloud consumer on the physical resources of the cloud service provider results in a determination by the cloud consumer that twelve VMs have been allocated by the cloud service provider within the same datacenter in violation of the virtual resource placement policy of the cloud consumer which requires that no more than ten VMs be allocated in any given datacenter, the cloud consumer may wish to have two of the twelve VMs moved to a different datacenter(s). However, the cloud service provider may be unable or unwilling to handle such a complex request. Accordingly, the cloud consumer may request allocation of a two new VMs, with an expectation or hope that the two new VMs will be allocated by the cloud service provider in a datacenter(s) such that no more than ten VMs are allocated in any given datacenter. The allocation of the two new VMs by the cloud service provider results in a modified placement of the virtual resources of the cloud consumer on the physical resources of the cloud service provider. The cloud service provider may then obtain new virtual resource placement information and determine whether the modified placement of the virtual resources of the cloud consumer within the cloud environment of the cloud service provider satisfies or violates the virtual resource placement policy. The cloud consumer, based on a determination that the placement of the new VM by the cloud service provider satisfies the virtual resource placement policy, may then migrate users or connections off of two VMs from the set of twelve VMs that violated the virtual resource placement policy onto the two new VMs and then request deallocation of the two VMs from which the users or connections were migrated.

In this manner, the cloud consumer may indirectly manage the placement of virtual resources within the cloud environment of the cloud service provider where the cloud service provider is unable or unwilling to actively attempt to meet the virtual resource placement policy of the cloud consumer or even where the cloud service provider is unable or unwilling to handle relatively complex virtual resource placement configuration actions that would more easily bring about a placement of virtual resources of the cloud consumer that satisfies the virtual resource placement policy of the cloud consumer.

It will be appreciated that, in these and other examples, the specific function may be any suitable type of function (e.g., providing an application instance for an application provided by the cloud consumer, providing an SGW element for a voice-over-LTE solution provided by the cloud consumer, or the like).

It also will be appreciated, from these and other examples, that one or more additional corrective actions may be requested by the cloud consumer even after the placement of the virtual resources of the cloud consumer within the cloud environment of the cloud service provider satisfies the virtual resource placement policy of the cloud consumer.

At step 399, method 300 ends.

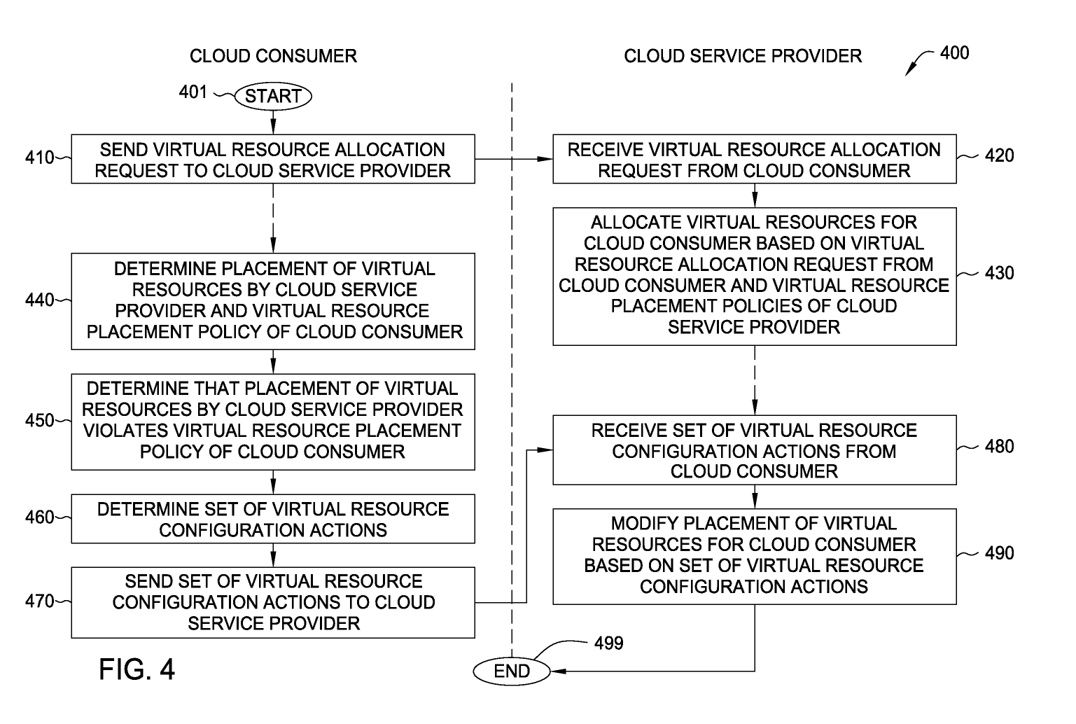

FIG. 4 depicts an exemplary embodiment of a method for managing placement of virtual resources of a cloud consumer in a cloud environment of a cloud service provider. As depicted in FIG. 4, a portion of the steps are performed by the cloud consumer (e.g., one or more systems of the cloud consumer) and a portion of the steps are performed by the cloud service provider (e.g., one or more systems of the cloud service provider). It will be appreciated that, although depicted and described as being performed serially, at least a portion of the steps of method 400 of FIG. 4 may be performed contemporaneously or in a different order than presented in FIG. 4.

At step 401, method 400 begins.

At step 410, the cloud consumer sends a virtual resource allocation request to the cloud service provider. At step 420, the cloud service provider receives the virtual resource allocation request from the cloud consumer. The virtual resource allocation request identifies the virtual resources requested (e.g., type(s), amount(s), or the like), one or more virtual resource placement policies according to which the cloud consumer needs or desires the virtual resources to be allocated within the cloud environment of the cloud service provider, or the like.

At step 430, the cloud service provider allocates virtual resources for the cloud consumer based on the virtual resource allocation request (e.g., allocating the type(s) and number(s) of virtual resources requested by the cloud consumer). The allocation of virtual resources for the cloud consumer produces thereby a placement of the virtual resources for the cloud consumer.

The cloud service provider allocates virtual resources for the cloud consumer based on one or more virtual resource placement policies of the cloud service provider. The one or more virtual resource placement rules of the cloud service provider are expected to include relatively simple virtual resource placement rules, as use of more complex virtual resource placement rules is expected to increase costs and reduce freedom of action of the cloud service provider.

The cloud service provider also may allocate virtual resources for the cloud consumer based on some of the virtual resource placement rules of the cloud consumer as specified in the one or more virtual resource placement policies of the cloud consumer. The one or more virtual resource placement rules of the cloud consumer are expected to include only relatively simple virtual resource placement rules, while excluding relatively complex virtual resource placement rules (e.g., application-specific or solution-specific virtual resource placement rules configured to take into account inter-function dependencies of functions performed for the cloud-based application or cloud-based solution to be supported). The failure of the cloud service provider to allocate virtual resources for the cloud consumer based on relatively complex virtual resource placement rules, or even for relatively simple virtual resource placement rules which may be requested by the cloud consumer, is expected to be due to the unwillingness or inability of the cloud service provider to support such virtual resource placement rules.

At steps 440-460, the cloud consumer performs functions enabling the cloud consumer to influence the placement of the virtual resources by the cloud service provider. At step 440, the cloud consumer determines the placement of virtual resources made by the cloud service provider (e.g., based on information received from the cloud service provider, based on monitoring of communications associated with use of virtual resources or the like) and determines a virtual resource placement policy of the cloud consumer (e.g., from a memory of virtual resource placement management system, from a memory of a operations support system, or the like). At step 450, the cloud consumer determines that the virtual resource placement made by the cloud service provider in step 430 violates the virtual resource placement policy of the cloud consumer. At step 460, the cloud consumer determines a set of virtual resource configuration actions based on the determination that the virtual resource placement made by the cloud service provider in step 430 violates the virtual resource placement policy of the cloud consumer. At step 470, the cloud consumer sends the set of virtual resource configuration actions to the cloud service provider. It will be appreciated that steps 460 and 470 of FIG. 4 may correspond to the corrective actions of step 340 of FIG. 3. It will be appreciated that steps 440-470 of FIG. 4 may be implemented using method 300 of FIG. 3 (where the audit performed at step 330 results in a determination that the virtual resource placement made by the cloud service provider violates one or more virtual resource placement policies of the cloud consumer).

At step 480, the cloud service provider receives the set of virtual resource configuration actions from the cloud consumer. At step 490, the cloud service provider modifies the virtual resource placement for the cloud consumer based on the set of virtual resource configuration actions from the cloud consumer.

At step 499, method 400 ends.

It will be appreciated that, although method 400 of FIG. 4 is primarily depicted and described with respect to an embodiment in which the cloud consumer provides its virtual resource placement policies to the cloud service provider, in at least some embodiments the cloud consumer may not provide any of its virtual resource placement policies to the cloud service provider for use in allocating virtual resources for the cloud consumer. It will be further appreciated that, in such embodiments, the cloud consumer may still audit the virtual resource placement made by the cloud service provider in step 430 to determine whether the virtual resource placement made by the cloud service provider satisfies or violates the one or more virtual resource placement policies of the cloud consumer.

It will be appreciated that various embodiments of the virtual resource placement management capability (e.g., method 300 of FIG. 3, method 400 of FIG. 4, or the like) enable the cloud consumer to influence the virtual resource placement provided to the cloud consumer by the cloud service provider, as many cloud service providers lack the capability or desire to analyze the virtual resource placement policy of the cloud consumer to ensure that the virtual resource placement provided for the cloud consumer conforms to the virtual resource placement policy of the cloud consumer. Thus, it will be appreciated that various embodiments of the virtual resource placement management capability benefit both the cloud consumer and the cloud service provider.

It will be appreciated that various embodiments of virtual resource placement management capability ensure, or at least improve the likelihood, that a cloud service provider supporting an application or solution for a cloud consumer supports the set of application-specific or solution-specific virtual resource placement rules necessary or desirable for operating the application or solution. This may ensure, or at least improve the likelihood, that the cloud consumer is able to operate the application or solution in a manner tending to reduce risks for the cloud consumer (e.g., for cloud consumer operating high reliability solutions, such as wireless service providers), increase availability and reliability of the application or solution, improve quality of experience for users of the application or solution, or the like, as well as various combinations thereof. This also may facilitate support by cloud service providers of more complex virtual resource placement rules (e.g., application-specific or solution-specific virtual resource placement rules, as opposed to simpler virtual resource placement rules such as simpler server-based or rack-based anti-affinity rules) without unduly burdening the freedom of action of the cloud service provider (e.g., the ability of the cloud service provider to migrate virtual resources, take actions in efforts to minimize operational expenditures, or the like).

It will be appreciated that various embodiments of virtual resource placement management capability may support a combination of (1) auditing and enforcement of a first type or set of virtual resource placement rules (e.g., richer or more complex virtual resource placement rules such as application-specific or solution specific rules which may include intra-function or inter-function virtual resource placement rules) by the cloud consumer and (2) enforcement of a second type or set of virtual resource placement rules (e.g., simpler or less complex virtual resource placement rules such as server-based or rack-based anti-affinity rules) by the cloud service provider. It will be appreciated that at least some such embodiments may enable even more complex, multi-element (e.g., multi-function, multi-product, or the like) solutions (e.g., voice-over-LTE, IMS, or the like) to be deployed to the cloud with acceptably small and brief service impact on failure.

It will be appreciated that, although primarily depicted and described with respect to embodiments in which a cloud consumer manages placement of its virtual resources within a cloud environment of a cloud service provider where the cloud service provider may be unable or unwilling to perform placement of the virtual resources of the cloud consumer while taking into account a virtual resource placement policy of the cloud consumer, it is possible that some cloud service providers may be able and willing to perform placement of the virtual resources of the cloud consumer while taking into account a virtual resource placement policy of the cloud consumer. Thus, various embodiments may be provided for enabling a cloud consumer to specify a virtual resource placement policy for use by a cloud service provider in placing virtual resources of the cloud consumer onto physical resources of the cloud service provider. In at least some embodiments, a virtual resource placement system or function of a cloud service provider may be configured to (1) receive, from a cloud consumer, a request for virtual resources, (2) identify an ‘anywhere-but-here’ virtual resource placement rule of the cloud consumer (e.g., stored by the cloud service provider where the cloud consumer previously provided the rule to the cloud service provider, provided by the cloud consumer in conjunction with the request for virtual resources, or the like), and determine placement of the requested virtual resources onto the physical resources of the cloud service provider based on the anywhere-but-here’ virtual resource placement rule and, optionally, based on one or more other virtual resource placement rules of the cloud consumer or one or more virtual resource placement rules of the cloud service provider. In at least some embodiments, an anywhere-but-here’ virtual resource placement rule of the cloud consumer may be specified as a list of physical resources of the cloud service provider (e.g., a specific rack of a datacenter, a specific host server(s), a specific processor(s) of a specific host server, or the like) onto which virtual resources cannot be placed by the cloud service provider. In at least some embodiments, an anywhere-but-here’ virtual resource placement rule of the cloud consumer may be specified for any virtual resources of the cloud consumer (e.g., do not place the requested virtual resources on rack 10 of the datacenter, do not place any virtual resources on host server 8 of datacenter 3, or the like), for specific virtual resources or groups of virtual resources (e.g., do not place the requested virtual resources on the same processor as virtual resource X, do not place the requested virtual resources on the same host server as virtual resources A or B, do not place the requested virtual resources on the same rack(s) as any virtual resources providing function Z, or the like). In at least some embodiments, a virtual resource placement system or function of a cloud service provider may be configured to determine placement of virtual resources of a cloud consumer onto physical resources of the cloud service provider based on an ‘anywhere-but-here’ virtual resource placement rule of the cloud consumer by (1) generating an ordered list of available physical resources (e.g., host servers, processors of host servers, or the like) of the cloud service provider onto which the virtual resources of the cloud consumer may be mapped and (2) selecting physical resources onto which the virtual resources of the cloud consumer are to be mapped without violating the ‘anywhere-but-here’ virtual resource placement rule of the cloud consumer. For example, the cloud service provider may select the first physical resource(s) on the ordered list that are not explicitly excluded by the ‘anywhere-but-here’ virtual resource placement rule of the cloud consumer. It will be appreciated that, although these embodiments are primarily described with respect to a virtual resource placement policy of a cloud consumer that only includes an ‘anywhere-but-here’ virtual resource placement rule, the virtual resource placement policy of the cloud consumer may include various other virtual resource placement rules (e.g., anti-affinity rules, intra-function placement rules, inter-function placement rules, or the like) that may be specified by the cloud consumer.

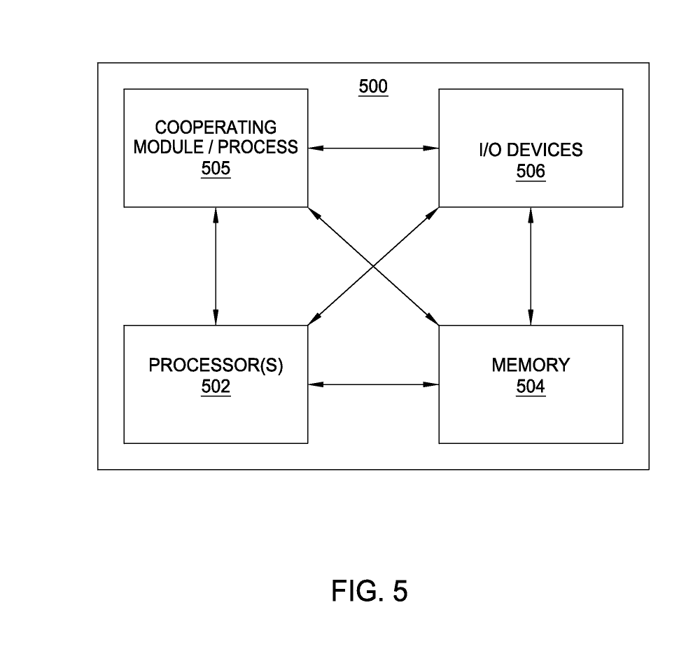

FIG. 5 depicts a high-level block diagram of a computer suitable for use in performing functions described herein.

The computer 500 includes a processor 502 (e.g., a central processing unit (CPU) and/or other suitable processor(s)) and a memory 504 (e.g., random access memory (RAM), read only memory (ROM), or the like).

The computer 500 also may include a cooperating module/process 505. The cooperating process 505 can be loaded into memory 504 and executed by the processor 502 to implement functions as discussed herein and, thus, cooperating process 505 (including associated data structures) can be stored on a computer readable storage medium, e.g., RAM memory, magnetic drive, optical drive, disk, diskette, or the like.

The computer 500 also may include one or more input/output devices 506 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 500 depicted in FIG. 5 provides a general architecture and functionality suitable for implementing functional elements described herein and/or portions of functional elements described herein. For example, computer 500 provides a general architecture and functionality suitable for implementing one or more of a PR 112 or a set of PRs 112 of a DC 111, a host 212, a ToR switch 220, an AS 230, router 240, OSS 121, VRPMS 122, a CD 130, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive configuration information indicative of placement of virtual resources of a cloud consumer on physical resources of a cloud environment of a cloud service provider;
receive a virtual resource placement policy of the cloud consumer; and
determine, based on the configuration information and the virtual resource placement policy of the cloud consumer, whether the placement of the virtual resources of the cloud consumer on the physical resources of the cloud service provider satisfies or violates the virtual resource placement policy of the cloud consumer.

2. The apparatus of claim 1, wherein the processor is configured to:
determine a virtual resource configuration action configured to produce a modified placement of the virtual resources of the cloud consumer on the physical resources of the cloud service provider; and
propagate the virtual resource configuration action toward a system of the cloud service provider.

3. The apparatus of claim 2, wherein the processor is configured to:
receive modified configuration information indicative of the modified placement of virtual resources of the cloud consumer on the physical resources of the cloud service provider; and
determine whether the modified placement of the virtual resources of the cloud consumer on the physical resources of the cloud service provider satisfies or violates the virtual resource placement policy of the cloud consumer or a new virtual resource placement policy of the cloud consumer.

4. The apparatus of claim 1, wherein the processor is configured to:
based on a determination that the placement of the virtual resources of the cloud consumer on physical resources of the cloud service provider violates the virtual resource placement policy of the cloud consumer:
propagate, from a system of the cloud consumer toward a system of the cloud service provider, at least one message configured to produce a modified placement of the virtual resources of the cloud consumer on the physical resources of the cloud service provider.

5. The apparatus of claim 4, wherein the at least one message comprises a request by the cloud consumer for allocation of additional virtual resources within the cloud environment of the cloud service provider.

6. The apparatus of claim 5, wherein the processor is configured to:
receive modified configuration information indicative of the modified placement of virtual resources of the cloud consumer on physical resources of the cloud service provider, the modified placement of virtual resources of the cloud consumer including placement of the additional virtual resources requested by the cloud consumer; and
determine, based on the modified configuration information and the virtual resource placement policy of the cloud consumer, whether the modified placement of the virtual resources of the cloud consumer on the physical resources of the cloud service provider satisfies or violates the virtual resource placement policy of the cloud consumer.

7. The apparatus of claim 5, wherein the processor is configured to:
based on a determination that the modified placement of the virtual resources of the cloud consumer on the physical resources of the cloud service provider satisfies the virtual resource placement policy of the cloud consumer:
initiate migration of a set of users or a set of connections from existing virtual resources of the cloud consumer to the additional virtual resources of the cloud consumer; and
propagate, toward the cloud service provider, a request for the cloud service provider to deallocate the existing virtual resources of the cloud provider from which the set of users or the set of connections was migrated.

8. The apparatus of claim 1, wherein the processor is configured to:
initiate a corrective action based on a determination that the placement of the virtual resources of the cloud consumer on physical resources of the cloud service provider violates the virtual resource placement policy of the cloud consumer.

9. The apparatus of claim 1, wherein the configuration information comprises, for at least one of the virtual resources of the cloud consumer, at least one of an indication as to a datacenter in which the virtual resource is hosted, an indication as to a server rack in which the virtual resource is hosted, or an indication as to a physical server on which the virtual resource is hosted.

10. The apparatus of claim 1, wherein the processor is configured to:
receive at least a portion of the configuration information from a management system of the cloud consumer.

11. The apparatus of claim 10, wherein the management system comprises a system configured to manage at least one of an application supported by the virtual resources or a solution supported by the virtual resources.

12. The apparatus of claim 1, wherein the processor is configured to:
receive at least a portion of the configuration information from a management system of the cloud service provider.

13. The apparatus of claim 1, wherein the processor is configured to:
determine at least a portion of the configuration information based on analysis of communications with the cloud environment of the cloud service provider.

14. The apparatus of claim 1, wherein the virtual resource placement policy comprises at least one of an anti-affinity rule, a single-point-of-failure prevention rule, a rule indicative of physical resources onto which virtual resources are not to be placed, a rule specific to a function supported by the virtual resources, a rule specific to a combination of multiple functions supported by the virtual resources, a rule specific to an application supported by the virtual resources, a rule specific to a set of applications supported by the virtual resources, or a rule specific to a solution supported by the virtual resources.

15. The apparatus of claim 1, wherein the virtual resources comprise virtual resources supporting a cloud-based application of the cloud consumer, wherein the virtual resource placement policy is specific to the cloud-based application of the cloud consumer.

16. The apparatus of claim 1, wherein the virtual resources comprise virtual resources supporting a cloud-based solution of the cloud consumer, wherein the cloud-based solution of the cloud consumer comprises a set of cloud-based applications configured to provide the cloud-based solution of the cloud consumer, wherein the virtual resource placement policy is specific to one or more of the cloud-based applications.

17. The apparatus of claim 1, wherein the virtual resources comprise virtual resources supporting a cloud-based solution of the cloud consumer, wherein the cloud-based solution of the cloud consumer comprises a set of functions configured to provide the cloud-based solution of the cloud consumer, wherein the virtual resource placement policy comprises an intra-function virtual resource placement policy for one of the functions or an inter-function virtual resource placement policy for at least two of the functions.

18. A method, comprising:
using a processor and a memory for:
receiving configuration information indicative of placement of virtual resources of a cloud consumer on physical resources of a cloud environment of a cloud service provider;
receiving a virtual resource placement policy of the cloud consumer; and
determining, based on the configuration information and the virtual resource placement policy of the cloud consumer, whether the placement of the virtual resources of the cloud consumer on the physical resources of the cloud service provider satisfies or violates the virtual resource placement policy of the cloud consumer.

19. A non-transitory computer-readable storage medium storing instructions which, when executed by a computer, cause the computer to perform a method, the method comprising:
receiving configuration information indicative of placement of virtual resources of a cloud consumer on physical resources of a cloud environment of a cloud service provider;
receiving a virtual resource placement policy of the cloud consumer; and
determining, based on the configuration information and the virtual resource placement policy of the cloud consumer, whether the placement of the virtual resources of the cloud consumer on the physical resources of the cloud service provider satisfies or violates the virtual resource placement policy of the cloud consumer.

20. An apparatus, comprising:
a processor and a memory communicatively connected to the processor, the processor configured to:
receive a virtual resource allocation request of a cloud consumer, the virtual resource allocation request comprising a request by the cloud consumer for allocation of virtual resources for the cloud consumer on physical resources of a cloud service provider;
determine a virtual resource placement rule of the cloud consumer, the virtual resource placement rule indicative of physical resources of the cloud service provider onto which the virtual resources requested by the cloud consumer are not to be placed; and
determine a placement of the virtual resources within the cloud environment of the cloud service provider based on the virtual resource placement rule of the cloud consumer.
